(19) United States
(12) Patent Application Publication
(10) Pub. No.: US 2010/0109574 A1
(43) Pub. Date: May 6, 2010

(54) ARRANGEMENT INCLUDING AN ELECTRONIC BALLAST AND DIMMING CONTROL APPARATUS CONNECTED THERETO, AND METHOD FOR OPERATING A LAMP

(75) Inventors: Werner Longhino, Mehring (DE); Robert Struebl, Traunwalchen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/610,394

(22) Filed: Nov. 2, 2009

(30) Foreign Application Priority Data
Nov. 3, 2008 (DE) 10 2008 054 290.3

(51) Int. Cl. H05B 37/02

(52) U.S. Cl. 315/307

(57) ABSTRACT

An arrangement is provided, including an electronic ballast having two terminals to which the electronic ballast applies voltage during operation, wherein the electronic ballast is configured to distinguish between different loads connected to the terminals and thus to obtain an analysis result, wherein it is configured to drive a lamp, which is connected to it, as a function of the analysis result; and a control apparatus, which is connected to the two terminals and draws energy for its operation via a voltage present at the two terminals, and which has a clock and can change the load, which is present between the two terminals, via an electronic controller as a function of information or signals provided by the clock.

### CROSS-REFERENCE TO RELATED APPLICATION

This application claims priority to German Patent Application Serial No. 10 2008 054 290.3, which was filed Nov. 3, 2008, and is incorporated herein by reference in its entirety.

### TECHNICAL FIELD

Various embodiments relate to an arrangement including an electronic ballast and dimming control apparatus connected thereto, and a method for operating a lamp.

### BACKGROUND

Most lamps can be operated in different modes which differ in terms of the light intensity emitted by the lamp. Lamps are usually operated such that they emit light at relatively high intensity in a normal mode, and it is possible to change to a dimmed mode in which the lamp emits light of considerably lower intensity. The dimmed operation saves energy. However, often a high intensity of the light emission is desired. Consequently it is necessary to control when a change is to be carried out from normal operation to dimmed operation. In the field of street lighting it is customary to change after a predetermined period of time of between four and six hours after the lamp being switched on to a dimmed operation.

Various embodiments relate to this change between two operating modes of the lamp and thus involve a method for operating a lamp. For this, Various embodiments provide a novel arrangement including an electronic ballast and a dimming control apparatus connected thereto.

Various embodiments proceed from the assumption that a conventional electronic ballast is used. Conventional electronic ballasts have a particular type of interface: during operation, the electronic ballast applies a voltage to two terminals (or between two terminals) of said electronic ballast. The electronic ballast can now distinguish between differing loads connected to the terminals. An electronic ballast typically includes a transformer, with alternating voltage being applied to the transformer on its primary side. Said two terminals of the electronic ballast are coupled to the secondary side which also has a rectifier. Then, a constant voltage is present. If a load is connected between the two terminals, said load influences the entire arrangement and effects in particular a change in potentials at the primary side of the transformer. If such a potential is measured at the primary side, it can be used as a basis on which to infer the load. In an extreme case, a voltage source is connected to the two terminals, and since such a voltage source has a very high internal resistance, the load is thus very great. The voltage present at the voltage source then influences the potential which is measured at the primary side of the transformer in the electronic ballast.

An interface of the type described above is defined, for example, in the IEC standard 60929, in its annex E2. The standard deals with the special case of an electronic ballast for a fluorescent lamp. Various embodiments can also be applied in electronic ballasts for halogen lamps, high-pressure lamps and LEDs, in which the interface can then be of a design similar to said interface for fluorescent lamps.

The interface is usually used to transmit control commands to the electronic ballast.

In an arrangement including a plurality of lamps with associated electronic ballasts, provision is usually made of a central control unit which is coupled to the respective interfaces. However, it does not appear sensible to provide such an arrangement merely for reporting the expiration of a predetermined dim period to the electronic ballasts since the outlay in cabling is extremely high: each electronic ballast must be individually connected to the central control unit.

### SUMMARY

An arrangement is provided, including an electronic ballast having two terminals to which the electronic ballast applies voltage during operation, wherein the electronic ballast is configured to distinguish between different loads connected to the terminals and thus to obtain an analysis result, wherein it is configured to drive a lamp, which is connected to it, as a function of the analysis result; and a control apparatus, which is connected to the two terminals and draws energy for its operation via a voltage present at the two terminals, and which has a clock and can change the load, which is present between the two terminals, via an electronic controller as a function of information or signals provided by the clock.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an arrangement including an electronic ballast with a dimming apparatus connected thereto according to an embodiment and furthermore a lamp connected thereto; and

FIG. 2 shows the principle design of the dimming control apparatus in FIG. 1 using a block diagram.

### DESCRIPTION

The following detailed description refers to the accompanying drawings that show, by way of illustration, specific details and embodiments in which the invention may be practiced.

Various embodiments show how the expiration of a dim period can be reported to an electronic ballast without much outlay.

The electronic ballast of the arrangement is in various embodiments distinguished by the fact that it is configured to drive a lamp, which is connected to it, as a function of the result of the analysis relating to the load connected to the terminals.

Predominantly, however, a (dimming) control apparatus is connected to the two terminals, which draws energy for its operation (in particular exclusively) via a voltage present at the two terminals. While the conventional interface does not allow for a large power output, with at most currents in the μA range flowing across the two terminals, it is possible to configure a power-efficient dimming control apparatus by using only electronic components. The dimming control apparatus has a clock and can change the load, which is present between the two terminals, via an electronic controller as a function of information provided by the clock or on the basis of signals emitted by the clock. In the simplest case, a circuit having a transistor is used and the electronic controller is used to change the potential present at its control input (base or gate), while the two other terminals (collector or source on the one hand, and emitter or drain on the other) of the transistor are coupled to the two terminals of the electric ballast via further elements such as a Zener diode, a plurality of diodes and/or resistors.

The provision of the arrangement according to various embodiments can effect time control of a lamp connected to the electronic ballast, without the need for excessive cabling outlay. The dimming control apparatus can in this case be accommodated, together with the electronic ballast, in the body of a luminaire, and no external control lines to the luminaire are necessary. The dimming control apparatus can simply be coupled to the electronic ballast without the need for an inspection by a testing organization.

Complex time specifications are possible owing to the provision of the clock.

In the simplest case, for which the arrangement according to various embodiments is predominantly provided, the dimming control apparatus should (as its name suggests) determine the time when a lamp connected to the electronic ballast is intended to be dimmed. Therefore, it is necessary only to distinguish between two states, specifically “not dimmed” and “dimmed”. Accordingly, the dimming control apparatus is, in the simplest case, configured to change from a first state with respect to the load present into a second state. The electronic ballast merely needs to be configured to distinguish between these two states of the dimming control apparatus connected thereto, and in the first state it drives a lamp connected to it in a manner such that the latter emits light of a first intensity, and in the second state it drives the lamp in a manner such that it emits light of a second intensity which is reduced with respect to the first intensity (that is to say dimmed light).

In a particularly simple case, it is not even necessary to change back to normal operation after the dimming In the simplest case a dimming control apparatus should merely ensure that the lamp is dimmed after a predetermined period of time has elapsed since it was switched on. Said period of time should be determined by the dimming control apparatus. It is possible to provide various dimming control apparatuses in each case for different such periods of time, so that in each case the required dimming control apparatus should then be connected to the electronic ballast. The predetermined period of time can, however, also be stored as a data value in the dimming control apparatus and can be varied via inputs. In any case, various embodiments enable the dimming of a lamp after a predetermined period of time has elapsed since it was switched on, without the need for this period of time to be stored in the electronic ballast itself Rather, the predetermined period of time is specified to the dimming control apparatus, and the latter may be configured to wait for the passing of exactly said predetermined period of time since the beginning of its supply with voltage (specifically, via the two terminals of the electronic ballast) and to subsequently effect a change in the load which is present between the two terminals.

In the dimming control apparatus, it may be provided that a basic state is automatically established at the beginning of its supply with voltage, that is to say the first state, and that there is a need for an active measure in order to change into another state, specifically the second state. The dimming control apparatus in this case has the function of a clock timer, except that it itself draws its voltage from the electronic ballast to which it sends reports via the voltage terminals, as it were, which reports are processed by the electronic ballast virtually in the manner of a control command

The method according to various embodiments for operating a lamp may include the following steps:
the lamp is coupled to an electronic ballast,
a dimming control apparatus is connected to two input terminals of the electronic ballast,
the application of a voltage to (or between) two mains terminals of the electronic ballast is started,
then firstly the electronic ballast begins to drive the lamp for a first operating mode, that is to say to transfer the lamp to a first operating mode by way of controlling the supply of a voltage thereto and, if appropriate, by way of control signals, and secondly, a voltage is initially applied, by way of the electronic ballast, to the input terminals, and thus sets the dimming control apparatus into operation,
the dimming control apparatus waits for a predetermined period of time after it is set into operation,
and after the predetermined period of time has elapsed,
a change in the load present at the input terminals is effected and
the load change is detected by the electronic ballast and, therefore, the lamp is subsequently driven for a second operating mode (that is to say a suitable supply of voltage and, if appropriate, control signals causes the lamp to operate in a second operating mode).

The first operating mode may be a mode in which the lamp operates normally and the second operating mode may be a mode in which the lamp operates in a dimmed fashion. In other words, the lamp may emit light of lower intensity in the second operating mode than in the first operating mode.

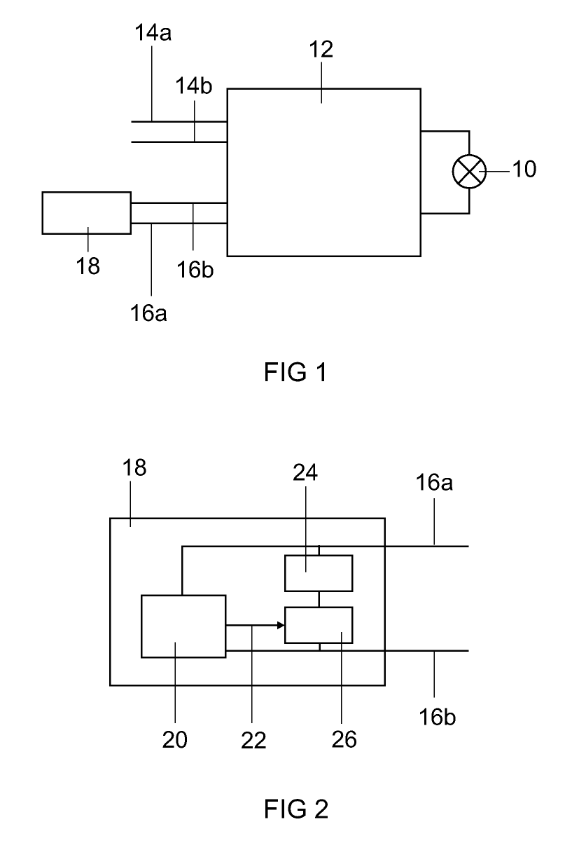

As shown in FIG. 1, a lamp 10 is driven by an electronic ballast 12 in an as such conventional manner The electronic ballast 12 can be coupled, via mains terminals 14a, 14b, to a power supply system. Internal circuits in the electronic ballast 12 may have the effect that the lamp 10 is driven with a suitable operating voltage, wherein the energy is drawn via the power supply system which is connected to the mains terminals 14a and 14b. The electronic ballast 12 has an interface with two input terminals 16a and 16b. As soon as there is a voltage present at the mains terminals 14a and 14b of the electronic ballast 12, the electronic ballast itself applies a voltage to the terminals 16a and 16b. Electric energy is supplied to a dimming control apparatus 18 via said voltage.

The dimming control apparatus 18 may include a time controller 20. Specified in the time controller 20 may be a predetermined period of time, and the time controller 20 begins to record the time since the dimming control apparatus has been switched on, which occurs automatically when the voltage is applied to the terminals 16a and 16b, and emits a signal according to arrow 22 when the predetermined period of time has elapsed.

Means or circuit 24 for limiting a voltage and a switching actuator 26 are now connected in series in the dimming control apparatus 18 in parallel to the time controller 20. The means or circuit 24 and the switching actuator 26 are thus present, as a load, at or between the terminals 16a and 16b. The means or circuit 24 for voltage limitation are, for example, in the form of a Zener diode, in the form of a series circuit of diodes other than Zener diodes, if appropriate only in the form of resistors, or they include a combination of Zener diodes, conventional diodes and/or resistors.

The switching actuator 26 is, in the simplest example, a transistor coupled to the output of an integrated circuit or of a microcontroller. It can also directly be the output of a microcontroller. If the transistor 26 is switched, specifically owing to the control command from the controller 20 according to the arrow 22, the load present at the terminals 16a and 16b changes temporarily. The electronic ballast 12 can detect a change in this load and changes its driving behavior. The electronic ballast 12 can thus, as soon as it is switched on, that is to say draws electric energy via the mains terminals 14a and 16b, drive the lamp 10 in normal operation. At the same time, the time controller 20 begins the recording of the time in the dimming control apparatus 18, and once a predetermined period of time has elapsed, the load is changed due to the control command according to the arrow 22, the electronic ballast 12 detects this and changes the driving of the lamp 10 such that the latter is subsequently operated in dimmed mode.

In the case of a conventional interface of the electronic ballast 12 with terminals 16a and 16b, which interface is also referred to as 1 to 10 V interface, the dimming control apparatus should after being switched on first of all leave the voltage between the terminals 16a and 16b at above 10 V, and once the switching actuator 26 has been activated, this voltage should drop to a value of between 1 and 10 V. A 1 to 10 V interface has two input terminals which are coupled, via a rectifier, to the secondary side of a transformer. When the load at the input terminals 16a and 16b changes, the voltage which drops on the primary side of the transformer when alternating voltage is applied changes, and said voltage can be measured so that the electronic ballast 12 detects here that the switching actuator 26 has been activated.

If the dimming control apparatus 18 is connected to an interface which is already present in conventional electronic ballasts 12 as a matter of course, time control is thus provided for the electronic ballast 12 and thus indirectly for the lamp 10 without much outlay. The time control is not provided internally in the electronic ballast 12. A change in time control can be effected by way of the use of another dimming control apparatus for which another predetermined time is pre-defined.

The outlay in terms of cabling is low since the dimming control apparatus 18 draws the energy for its operation exclusively via the terminals 16a and 16b. There is therefore no need for separate mains terminals for the dimming control apparatus 18. A dimming control apparatus 18 having the properties described can be provided as a simple electronic circuit, if appropriate with a few intelligent elements such as microcontrollers etc., which circuit uses little electric energy and at the same time takes up little space. The dimming control apparatus 18, together with the electronic ballast 12, can thus be accommodated easily in a luminaire, which surrounds the lamp 10.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An arrangement, comprising:
an electronic ballast having two terminals to which the electronic ballast applies voltage during operation, wherein the electronic ballast is configured to distinguish between different loads connected to the terminals and thus to obtain an analysis result, wherein it is configured to drive a lamp, which is connected to it, as a function of the analysis result; and
a control apparatus, which is connected to the two terminals and draws energy for its operation via a voltage present at the two terminals, and which has a clock and can change the load, which is present between the two terminals, via an electronic controller as a function of information or signals provided by the clock.

2. The arrangement as claimed in claim 1,
wherein the control apparatus is configured, as a dimming control apparatus, to change from a first state with respect to the load present into a second state with respect to the load present, wherein the electronic ballast is configured to distinguish between these two states, and to drive, in the first state, a lamp connected to it in a manner such that the latter emits light of a first intensity, and to drive, in the second state, the lamp in a manner such that it emits light of a second intensity which is reduced with respect to the first intensity.

3. The arrangement as claimed in claim 2,
wherein a predetermined period of time is specified to the dimming control apparatus, which is configured to wait for the passing of the predetermined period of time since the beginning of its supply with voltage and to subsequently effect a change in the load which is present between the two terminals.

4. A method for operating a lamp, comprising:
coupling the lamp to an electronic ballast;
connecting a dimming control apparatus to two input terminals of the electronic ballast;
starting the application of a voltage to two mains terminals of the electronic ballast;
then firstly, by the electronic ballast, beginning to drive the lamp for a first operating mode, and secondly, initially applying a voltage, by way of the electronic ballast, to the input terminals, and thus setting into operation the dimming control apparatus:
the dimming control apparatus waiting for a predetermined period of time after it is set into operation;
and after the predetermined period of time has elapsed,
effecting a change in the load present at the input terminals; and
detecting the change in the load by the electronic ballast and, therefore, subsequently driving the lamp for a second operating mode.

5. The method as claimed in claim 4,
wherein the lamp emits light of lower intensity in the second operating mode than in the first operating mode.
